(19) United States
(12) Patent Application Publication
(10) Pub. No.: US 2016/0121575 A1
(43) Pub. Date: May 5, 2016

(54) LAMINATE SHEET AND PROCESS FOR PRODUCING SAME

(71) Applicant: Asahi Glass Company, Limited, Chiyoda-ku (JP)

(72) Inventors: Yoshiaki HIGUCHI, Chiyoda-ku (JP); Shun SAITO, Chiyoda-ku (JP); Kiyoshi KASAHARA, Chiyoda-ku (JP)

(73) Assignee: Asahi Glass Company, Limited, Chiyoda-ku (JP)

(21) Appl. No.: 14/992,135

(22) Filed: Jan. 11, 2016

Related U.S. Application Data
(63) Continuation of application No. PCT/JP2014/069247, filed on Jul. 18, 2014.

(30) Foreign Application Priority Data
Jul. 26, 2013 (JP) 2013-155802
Dec. 25, 2013 (JP) 2013-267915

(51) Int. Cl. B32B 5/02; B32B 27/32; B29C 70/08; B32B 27/12

(52) U.S. Cl. CPC B32B 5/02; B32B 27/12; B32B 27/322; B29C 70/086; B32B 2262/101; B32B 2307/3065; B32B 2307/412; B32B 2307/712; B32B 2419/06

(57) ABSTRACT

To provide a laminate sheet having flame retardancy, transparency and excellent weather resistance, and to provide a production process thereof.

A laminate sheet 10, comprising:
a layer of a fiber-reinforced resin sheet, which comprises a matrix 12 containing a fluorine atom-free resin, and a glass fiber cloth 14 having an open area ratio of at most 20%, embedded in the matrix 12, and
a fluorinated resin layer 16 containing a fluorinated resin and an ultraviolet absorber, provided on at least one side of the layer of a fiber-reinforced resin sheet.

### TECHNICAL FIELD

The present invention relates to a laminate sheet comprising a layer of a fiber-reinforced resin sheet and a fluorinated resin layer, and a process for producing the same.

### BACKGROUND ART

A fiber-reinforced resin sheet is used as a membrane material (such as a roof material or an exterior wall material) for membrane structure buildings (such as sports facilities, large-scale greenhouses and atria). The fiber-reinforced resin sheet as a membrane material for membrane structure buildings is required to have e.g. flame proofing property and weather resistance. Further, some of the membrane structure buildings require transparency (high light transmittance and low haze).

As a fiber-reinforced resin sheet having flame proofing property and high transparency, for example, the following one has been proposed.

A transparent nonflammable sheet having a glass fiber woven fabric and a pair of cured resin layers sandwiching the glass fiber woven fabric, wherein the difference in refractive indices between the glass fibers and the cured resin is at most 0.02, and the difference in the Abbe number between the glass fibers and the cured resin is at most 30 (Patent Document 1).

### PRIOR ART DOCUMENT

### Patent Document

Patent Document 1: JP-A-2005-319746

### DISCLOSURE OF INVENTION

### Technical Problem

However, the above transparent nonflammable sheet is insufficient in weather resistance since a resin material is a cured resin.

It is an object of the present invention to provide a laminate sheet having flame proofing property and transparency, and being excellent in weather resistance.

### Solution to Problem

The present invention provides a laminate sheet, and a production process thereof, having the following constructions [1] to [14].

[1] A laminate sheet, comprising:

a layer of a fiber-reinforced resin sheet, which comprises a matrix containing a fluorine atom-free resin, and a glass fiber cloth having an open area ratio of at most 20%, embedded in the matrix, and

a fluorinated resin layer containing an ultraviolet absorber, provided on at least one side of the layer of a fiber-reinforced resin sheet.

[2] The laminate sheet according to [1], wherein the absolute value of the difference between the refractive index of the matrix and the refractive index of a glass fiber constituting the glass fiber cloth is at most 0.02.
[3] The laminate sheet according to [1] or [2], wherein the total light transmittance of the laminate sheet is at least 85%.
[4] The laminate sheet according to any one of [1] to [3], wherein the haze of the laminate sheet is at most 30%.
[5] The laminate sheet according to any one of [1] to [4], wherein the fluorine atom-free resin is a cured product of a curable resin material.
[6] The laminate sheet according to any one of [1] to [4], wherein the fluorine atom-free resin is a thermoplastic resin.
[7] The laminate sheet according to any one of [1] to [6], wherein the fluorinated resin is a cured product of a fluoroolefin copolymer having reactive functional groups.
[8] The laminate sheet according to [7], wherein the fluoroolefin copolymer having reactive functional groups is a copolymer having units derived from a fluoroolefin and units derived from a monomer having a reactive functional group, said monomer being copolymerizable with the fluoroolefin.
[9] The laminate sheet according to [7] or [8], wherein the fluoroolefin copolymer having reactive functional groups is a fluoroolefin copolymer having hydroxy groups.
[10] The laminate sheet according to any one of [1] to [6], wherein the fluorinated resin is a homopolymer or copolymer having units derived from a fluoroolefin.
[11] The laminate sheet according to [10], wherein the fluorinated resin is an ethylene/tetrafluoroethylene copolymer.
[12] The laminate sheet according to any one of [1] to [10], which is a membrane material for membrane structure buildings.
[13] A process for producing the laminate sheet as defined in any one of [7] to [9], which comprises:

producing the fiber-reinforced resin sheet,

coating one side or both sides of the fiber-reinforced resin sheet with a solution of a curable resin material containing a fluoroolefin copolymer having reactive functional groups and an ultraviolet absorber,

removing a solvent to form a layer of the curable resin material, and then

curing the curable resin material to form a fluorinated resin layer containing the ultraviolet absorber.

[14] A process for producing the laminate sheet as defined in [10] or [11], which comprises:

producing the fiber-reinforced resin sheet, and then

laminating a film or sheet of the fluorinated resin on one side or both sides of the fiber-reinforced resin sheet.

### Advantageous Effects of Invention

The laminate sheet of the present invention has flame proofing property and transparency, and are excellent in weather resistance.

According to the process for producing a laminate sheet of the present invention, it is possible to produce a laminate sheet having flame proofing property and transparency, and being excellent in weather resistance.

### BRIEF DESCRIPTION OF DRAWINGS

FIG. 1 is a cross-sectional view illustrating one embodiment of the laminate sheet of the present invention.

FIG. 2 is a cross-sectional view illustrating another embodiment of the laminate sheet of the present invention.

### DESCRIPTION OF EMBODIMENTS

The following definitions of terms are applied throughout this specification and of claims.

“Fiber-reinforced resin sheet” means a molded resin sheet having a fiber cloth embedded therein.

“Matrix” means a part of a resin material other than the fiber cloth, in the fiber-reinforced resin sheet.

“Curable resin material” means a resin material having curability, containing a curable resin component and, as the case requires, e.g. a curing agent, a curing catalyst and a polymerization initiator.

“Thermoplastic resin” means a resin material containing a thermoplastic resin.

“Fluorinated resin” means a polymer compound (hereinafter, referred to as “a fluorinated polymer”) having fluorine atoms in its molecule. Further, “fluorinated resin” also includes a cured product of a curable fluorinated polymer.

“Membrane structure building” means a building of which e.g. a roof or an exterior wall is totally or partly structured by a membrane material.

Units derived from a monomer in a polymer, are also referred to as monomer units. For example, units derived from olefin are also referred to as olefin units. [Laminate sheet]

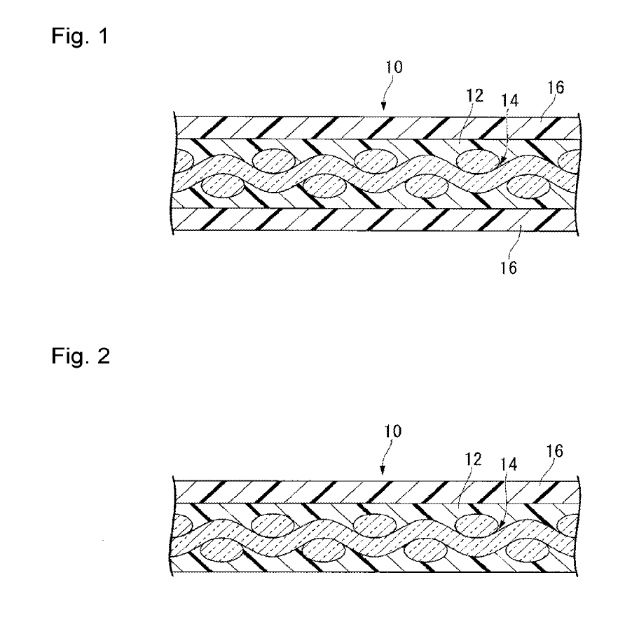

FIG. 1 is a cross-sectional view illustrating one embodiment of the laminate sheet of the present invention. Laminate sheet 10 has matrix resin 12 and glass fiber cloth 14 embedded in matrix resin 12, said laminate sheet 10 having such a layer of a fiber-reinforced resin sheet and fluorinated resin layers 16 provided on both sides of the layer of a fiber-reinforced resin sheet.

### (Fiber Reinforced Resin Sheet)

The matrix in the fiber-reinforced resin sheet is a solid form containing a fluorine atom-free resin, and it may contain an additive as the case requires.

The resin in the matrix may be a cured product of a curable resin material and a thermoplastic resin.

The thickness (at an intersection point of glass fibers) of the fiber-reinforced resin sheet is preferably at most 500 μm, particularly preferably at most 300 μm, in view of e.g. excellent light transparency and processability. The thickness of the matrix layer is preferably at least 50 μm, particularly preferably at least 100 μm, in view of e.g. excellent flame proofing property and strength.

### <Curable Resin Material>

The curable resin material may, for example, be a thermosetting resin material or a photocurable resin material.

The thermosetting resin material contains a curable resin component and a component capable of curing the curable resin component, such as a curing agent or a curing catalyst. In some cases, a thermosetting resin material being heat-curable from the curable resin component alone or a thermosetting resin material made of a mixture of two types of resin components, may also be used as the thermosetting resin material.

The photocurable resin material contains a curable resin component and a photopolymerization initiator which generates e.g. radicals or cations by light.

The thermosetting resin may, for example, be a thermosetting epoxy resin, a thermosetting acryl resin, a phenol resin, an unsaturated polyester resin, an urea resin, a melamine resin, a diallyl phthalate resin or a thermosetting silicone resin. In view of excellent transparency and weather resistance, a thermosetting acryl resin, a thermosetting epoxy resin, an unsaturated polyester resin or a thermosetting silicone resin is preferred. As the thermosetting silicone resin, a two-liquid curable silicone resin (for example, a mixture of a vinyl group-containing organopolysiloxane and a hydrogen silyl group-containing organopolysiloxane) is preferred.

The thermosetting resin material preferably contains a curing agent. Regarding the curing agent, as a curing agent for an epoxy resin, an amine type curing agent, an acid anhydride type curing agent or a polyamide type curing agent may, for example, be mentioned. In the case of other curable resins, a curing agent matching with the curable resins is used. For example, in the case of a curable resin component having an unsaturated double bond, a curing agent such as a polymerization initiator which generates radicals by heating is used.

The proportion of the curing agent contained in the thermosetting resin material is preferably from 0.2 to 20 parts by mass, particularly preferably from 0.5 to 10 parts by mass, per 100 parts by mass of the thermosetting resin.

The thermosetting resin material may further contain a curing catalyst (a curing accelerator). The curing catalyst may, for example, be an organic tin compound, an imidazole, an urea derivative, a tertiary amine or an onium salt.

The proportion of the curing catalyst contained in the thermosetting resin material is preferably from 0.1 to 10 parts by mass, particularly preferably from 0.5 to 5 parts by mass, per 100 parts by mass of the thermosetting resin.

The photocurable resin may, for example, be an ultraviolet-curable acryl resin (comprising a combination of a radical generating photopolymerization initiator and a compound having an acryloyloxy group such as a polyol acrylate, an epoxy-modified acrylate, an urethane-modified acrylate, a silicone-modified acrylate or an imide acrylate), an ultraviolet-curable epoxy resin (made of a combination of a cation-generating photopolymerization initiator and a compound having an epoxy group such as bisphenol A-diglycidyl ether). In view of excellent transparency, weather resistance and water resistance, an ultraviolet-curing acryl resin is preferred, and among them, an ultraviolet-curable epoxy-modified acrylate resin or an ultraviolet-curable silicone-modified acrylate resin is preferred.

The radical-generating photopolymerization initiator in the photocurable resin may, for example, be benzoin isopropyl ether, benzophenone, Michler's ketone, chlorothioxanthone, isopropylthioxanthone, benzyl dimethyl ketal, acetophenone dimethyl ketal, 1-hydroxycyclohexyl phenyl ketone or 2-hydroxy-2-methyl-phenylpropan-1-one. The cation-generating photopolymerization initiator may be a sulfonium type photopolymerization initiator or an iodonium type photopolymerization initiator.

The proportion of the photopolymerization initiator contained in the photocurable resin material is preferably from 0.1 to 10 parts by mass, particularly preferably from 0.25 to 5 parts by mass, per 100 parts by mass of the curable resin component.

The glass fiber cloth is impregnated with the curable resin material which is then cured to prepare a matrix resin. In a case where the curable resin material is a low-viscosity liquid, the glass fiber cloth may be impregnated with the curable resin material as it is. In a case where the curable resin material is solid or a high-viscosity liquid, the curable resin material is dissolved in a solvent to be a solution, the glass fiber cloth is impregnated with this solution, the solvent is then removed, and thereafter the curable resin material is cured.

The proportion of the cured product of the curable resin material is preferably at least 50 mass %, more preferably at least 60 mass %, particularly preferably at least 75 mass %, to the matrix (100 mass %). When the proportion of the cured product of the curable resin material is at least the above lower limit value, the fiber-reinforced resin sheet is excellent in transparency. The upper limit of the proportion of the cured product of the curable resin material is 100 mass %.

### <Thermoplastic Resin Material>

The thermoplastic resin may, for example, be polyvinyl chloride, polyvinylidene chloride, polyethylene, polypropylene, a methylpentene resin, polyvinyl alcohol, polyvinyl acetate, polyvinyl butyral, polyamide, polymethyl methacrylate, polyurethane, polycarbonate, polyester, polystyrene, polyacrylonitrile/styrene, polyethylene chloride, polypropylene chloride, polyurethane or a silicone resin, in view of transparency. With a view to impart higher transparency when integrated with a glass fiber cloth made of universal E glass, the thermoplastic resin is preferably polyvinyl chloride, polyethylene, polyamide, polymethyl methacrylate, polyethylene chloride, polypropylene chloride or polyurethane, which has a refractive index close to the E glass, and in addition, polyvinyl chloride, polyethylene chloride or polypropylene chloride is particularly preferred in view of flame retardancy.

The thermoplastic resin material is dissolved in a solvent to be a solution, the glass fiber cloth is impregnated with this solution, and then the solvent is removed to form a solid-form matrix.

The proportion of the thermoplastic resin is preferably at least 50 mass %, more preferably at least 60 mass %, particularly preferably at least 75 mass %, to the matrix (100 mass %). When the proportion of the thermoplastic resin is at least the above lower limit value, the fiber-reinforced resin sheet is excellent in transparency. The upper limit of the proportion of the thermoplastic resin is 100 mass %.

### <Additives>

The additive may, for example, be an ultraviolet absorber, a light stabilizer, an antioxidant, an infrared absorber, a flame retardant, a flame retarding filler, an organic pigment, an inorganic pigment, a dye or a thermoplastic resin.

The ultraviolet absorber may, for example, be an organic type ultraviolet absorber or an inorganic type ultraviolet absorber, as mentioned below.

The light stabilizer may, for example, be a hindered amine type light stabilizer.

The antioxidant is classified into a chain stopper, a peroxide decomposing agent or a metal deactivator, according to the difference of action mechanism. The antioxidant may, for example, be a phenol type antioxidant, a phosphorine type antioxidant, a sulfurine type antioxidant or an amine type antioxidant.

The flame retardant may, for example, be a phosphorine type flame retardant or a bromine type flame retardant.

The flame-retarding filler may, for example, be aluminum hydroxide or magnesium hydroxide.

### (Glass Fiber Cloth)

The glass fiber cloth is a woven or nonwoven fabric made of glass fibers. The glass fiber cloth may be one which is preliminarily fixed by a binder between glass fibers.

### <Glass Fibers>

The glass fibers may, for example, be glass fibers made of alkali-free glass (E glass) having SiO₂, Al₂O₃ and CaO as main components, glass fibers made of low dielectric glass (D glass) having SiO₂ and B₂O₃ as main components, and glass fibers made of silica glass most of which is SiO₂ alone. The glass fibers made of silica glass are preferably glass fibers containing at least 80 mass % of SiO₂, more preferably glass fibers containing at least 90 mass % of SiO₂, particularly preferably glass fibers containing at least 93 mass % of SiO₂.

The difference (absolute value) between the refractive index of the glass fibers and the refractive index of the matrix is preferably at most 0.20 with a view to increasing transparency, particularly preferably at most 0.10 with a view to reducing haze.

The refractive index is a refractive index to light with a wavelength of 589 nm, which is a numerical value measured in accordance with JIS Z8402-1.

A preferred combination of the glass fibers and the resin material so as to lessen the difference (absolute value) between the refractive index of the glass fibers and the refractive index of the matrix, is as follows.

In a case where the glass fibers are glass fibers made of E glass (refractive index (refractive index: 1.55), the resin material may be a cured product (refractive index: 1.55) of an epoxy-modified acrylate resin, a polymethyl methacrylate for a lens (refractive index: 1.55), polyethylene (refractive index: 1.53), polyamide (refractive index: 1.53), polyvinyl chloride (refractive index: 1.54) or polyurethane (refractive index: 1.53).

In a case where the glass fibers are glass fibers made of silica glass (refractive index: 1.45), a two-liquid curable silicone resin (refractive index: 1.43) may be mentioned.

### <Woven Fabric>

The woven fabric is preferably a woven fabric obtained by weaving yarn made of a plurality of glass single fibers, in view of flexibility and high strength of a woven fabric obtained.

The thickness of the glass single fibers is preferably from 0.018 to 1 Tex (g/1,000 m), particularly preferably from 0.07 to 0.46 Tex. When the thickness of the glass single fibers is at least the above lower limit value, the glass single fibers hardly break in production of a fiber-reinforced resin sheet. When the thickness of the glass single fibers is at most the above upper limit value, an woven fabric obtainable is excellent in flexibility and strength. The thickness of the glass single fibers is measured in accordance with JIS L0101.

The number of the glass single fibers constituting yarn is preferably from 5 to 1,000, particularly preferably from 10 to 300. When the number of the glass single fibers is at least the lower limit value, it is possible to facilitate handling in production of yarn. When the number of the glass single fibers is at most the upper limit value, it is possible to stably produce yarn.

The weaving density (lengthwise direction and lateral direction) of the yarn twisted is preferably from 10 to 200 mesh (number/inch), particularly preferably from 20 to 150 mesh. When the weaving density is at least the lower limit value, it is possible to increase the weaving speed in production of the woven fabric thereby to reduce a cost.

When the weaving density is at most the upper limit value, it is possible to obtain a woven fabric having a low open area ratio.

The weave of the woven fabric may, for example, be plane weaving, twill weaving, leno weaving or knitting.

The woven fabric may be one made of one type or at least two types of glass single fibers. Further, in the woven fabric, warps and wefts may have a different number of glass single fibers to constitute yarn.

### <Non-Woven Fabric>

The non-woven fabric is preferably one obtained by collecting a plurality of glass fibers and fixing a space between glass fibers by a binder, from the viewpoint of easiness of handling.

The basis weight of the non-woven fabric is preferably from 15 to 500 g/m², particularly preferably from 30 to 300 g/m². When the basis weight of the non-woven fabric is at least the lower limit value, the strength is excellent. When the basis weight of the non-woven fabric is at most the upper limit value, the resin material easily infiltrates into air gaps between glass fibers.

The thickness of the non-woven fabric is preferably from 80 to 600 μm, particularly preferably from 120 to 400 μm. When the thickness of the non-woven fabric is at least the lower limit value, the strength is excellent. When the thickness of the non-woven fabric is at most the upper limit value, the resin material can easily infiltrate into air gaps between the glass fibers.

The density of the non-woven fabric is preferably from 0.067 to 0.5 g/cm³, particularly preferably from 0.15 to 0.4 g/cm³. When the density of the non-woven fabric is at least the lower limit value, the strength is excellent. When the density of the non-woven fabric is at most the upper limit value, the resin material can easily infiltrate into air gaps between the glass fibers.

The binder may, for example, be polyvinyl alcohol, polyvinyl acetate, an acrylic resin, an epoxy resin, an unsaturated polyester resin or a melamine resin.

The non-woven fabric may be one made of one type or at least two types of glass fibers.

### <Open Area Ratio>

The open area ratio of the glass fiber cloth is at most 20%, preferably at most 15%, more preferably at most 12%, particularly preferably at most 9%. When the open area ratio of the glass fiber cloth is at most the upper limit value, the laminate sheet is excellent in flame proofing property. The open area ratio of the glass fiber cloth is preferably at least 1%, more preferably at least 2%, particularly preferably at least 3% from the viewpoint that a resin material can easily infiltrate into air gaps between the glass fibers.

The open area ratio of the glass fiber cloth is determined from the following formula (1).

Open area ratio=(distance between glass fibers in the lengthwise direction of glass fiber cloth×distance between glass fibers in the lateral direction of glass fiber cloth)/(distance between centers of glass fibers in the lengthwise direction of glass fiber cloth×distance between centers of glass fibers in the lateral direction of glass fiber cloth)×100 (1)

The open area ratio can be adjusted by changing e.g. the thickness of the glass fibers and the weaving density.

### (Fluorinated Resin Layer)

The fluorinated resin layer contains a fluorinated resin and an ultraviolet absorber, and as the case requires, other resins and other additives may be contained therein.

The thickness of the fluorinated resin layer is preferably at most 200 μm, more preferably at most 125 μm, particularly preferably at most 80 μm, in view of e.g. excellent transparency and processability. The thickness of the fluorinated resin layer is preferably at least 6 μm, particularly preferably at least 12 μm, in view of e.g. excellent weather resistance and strength.

### <Fluorinated Resin>

The fluorinated resin may be a homopolymer or copolymer of a fluoroolefin, or a cured product of a fluoroolefin copolymer having a reactive functional group.

The homopolymer or copolymer of the fluoroolefin is preferably one having thermal plasticity capable of molding into a film or sheet, or one having solvent-solubility capable of solution coating. Among them, the homopolymer or copolymer of the fluoroolefin having thermal plasticity is particularly preferred since the fluorinated resin layer can easily be formed by laminating a film or sheet. The copolymer may be a copolymer of at least two types of fluoroolefins, or a copolymer of at least one type of a fluoroolefin and at least one type of a monomer other than the fluoroolefin.

Further, the fluoroolefin copolymer having a reactive functional group is a copolymer having a solvent-solubility capable of solution coating, and is curable by itself or by the action of e.g. a curing agent. In the case of a fluoroolefin copolymer having a reactive functional group, it is possible to increase the content of an ultraviolet absorber in the fluorinated resin layer, and it is also excellent in solvent solubility.

The fluoroolefin may, for example, be vinyl fluoride, vinylidene fluoride, trifluoroethylene, chlorotrifluoroethylene, tetrafluoroethylene, pentafluoropropylene or hexafluoropropylene.

The fluoroolefin in the copolymer may be used alone or in combination of two or more of them.

The monomer (hereinafter, referred to as monomer (a)) other than fluoroolefin, copolymerizable with the fluoroolefin in the copolymer, may, for example, be a vinyl ether, an allyl ether, a carboxylic acid vinyl ester, a carboxylic acid allyl ester or an olefin. The monomer (a) such as a vinyl ether, except for an olefin, may have a fluorine atom. Specifically, a fluoroalkyl vinyl ether, a fluoroalkyl allyl ether or a fluoro unsaturated cyclic ether may, for example, be mentioned.

The monomer (a) used in the fluoroolefin copolymer having thermal plasticity is preferably a monomer having no reactive functional group, and further such a monomer, except for an olefin, may have a fluorine atom. Specifically, the monomer (a) may, for example, be an olefin such as ethylene, propylene or isobutylene, a vinyl ether such as a perfluoro(alkyl vinyl ether) or a (perfluoroalkyl) vinyl ether, or a fluoro unsaturated cyclic ether such as 2,2-bistrifluoromethyl-4,5-difluoro-1,3-dioxol.

The fluoroolefin polymer having thermal plasticity may, for example, be an ethylene/tetrafluoroethylene copolymer (hereinafter, referred to as ETFE), a tetrafluoroethylene/perfluoro(alkyl vinyl ether) copolymer, a tetrafluoroethylene/hexafluoropropylene copolymer, a polyvinylidene fluoride (hereinafter, referred to as PVDF), polyvinyl fluoride, a tetrafluoroethylene/hexafluoropropylene/polyvinylidene fluoride copolymer, a polychlorotrifluoroethylene (hereinafter, referred to as PCTFE), ethylene/chlorotrifluoroethylene copolymer or tetrafluoroethylene/2,2-bistrifluoromethyl-4,5-difluoro-1,3-dioxol copolymer.

The fluoroolefin polymer having thermal plasticity is preferably ETFE in view of excellent transparency and processability into a film.

The fluoroolefin polymer having a solvent-solubility is preferably PVDF. PVDF may be blended with polymethyl methacrylate (hereinafter, referred to as PMMA), and its blend resin may be used for solution coating.

As the monomer (a) used in a fluoroolefin copolymer having a reactive functional group, at least one type of the monomer having a reactive functional group is used, and further a monomer having no reactive functional group is used in combination.

The monomer having a reactive functional group is preferably a hydroxy group-containing monomer (hereinafter, referred to as monomer (a1)). Here, the monomer having no reactive functional group is hereinafter referred to as monomer (a2).

A copolymer having a hydroxy group is excellent in adhesion to the glass fiber cloth, and further it is capable of forming a fluorinated resin layer having high mechanical strength after curing. Further, when having the monomer (a2) unit, the copolymer further has other properties (such as solvent solubility, transparency, glossiness, hardness, flexibility and pigment dispersibility).

Monomer (a1) may, for example, be an allyl alcohol, a hydroxyalkyl vinyl ether (such as 2-hydroxyethyl vinyl ether, 4-hydroxybutyl vinyl ether or cyclohexanediol monovinyl ether), a hydroxyalkyl allyl ether (such as 2-hydroxyethyl allyl ether), a vinyl hydroxyalkanoate (such as vinyl hydroxypropionate), an acrylic acid hydroxyalkyl ester (such as hydroxyethyl acrylate) or a methacryl acid hydroxyalkyl ester (such as hydroxyethyl methacrylate).

Monomer (a1) may be used alone or in combination of two or more of them.

Monomer (a2) may, for example, be a vinyl ether, an allyl ether, a carboxylic acid vinyl ester, a carboxylic acid allyl ester or an olefin, having no reactive functional groups.

The vinyl ether having no reactive functional groups may, for example, be a cycloalkyl vinyl ether (such as cyclohexyl vinyl ether) or an alkyl vinyl ether (such as nonyl vinyl ether, 2-ethylhexyl vinyl ether, hexyl vinyl ether, ethyl vinyl ether, n-butyl vinyl ether or t-butyl vinyl ether).

The allyl ether having no reactive functional groups may, for example, be an alkyl allyl ether (such as ethyl allyl ether or hexyl allyl ether).

The carboxylic acid vinyl ester having no reactive functional groups may, for example, be a vinyl ester of carboxylic acid (such as acetic acid, butyric acid, pivalic acid, benzoic acid or propionic acid). Further, as a carboxylic acid vinyl ester having a branched alkyl group, a commercially available Veova 9 or Veova 10 (tradename, manufactured by Shell Kagaku K.K.) may, for example, be used.

The carboxylic acid allyl ester having no reactive functional groups may, for example be an allyl ester of carboxylic acid (such as acetic acid, butyric acid, pivalic acid, benzoic acid or propionic acid).

The olefin may, for example, be ethylene, propylene or isobutylene.

Monomer (a2) may be used alone or in combination of two or more of them.

Monomer (a2) is preferably one having a linear or branched alkyl group with at least three carbon atoms, in view of excellent flexibility of a fluorinated resin and good following property of a fluorinated resin layer to a fiber-reinforced resin sheet layer at the time of deforming a laminate sheet.

The combination of monomers to constitute a hydroxy group-containing fluoroolefin copolymer, is preferably the following combination (1), particularly preferably the following combination (2) or (3) among them, in view of flame proofing property, weather resistance, adhesion and flexibility.

### Combination (1)

Fluoroolefin: tetrafluoroethylene or chlorotrifluoroethylene,

Monomer (a1): hydroxyalkyl vinyl ether,

Monomer (a2): at least one selected from cycloalkyl vinyl ether, alkyl vinyl ether and carboxylic acid vinyl ester.

### Combination (2)

Fluoroolefin: tetrafluoroethylene,

Monomer (a1): hydroxyalkyl vinyl ether,

Monomer (a2): t-butyl vinyl ether and carboxylic acid vinyl ester.

### Combination (3)

Fluoroolefin: chlorotrifluoroethylene,

Monomer (a1): hydroxyalkyl vinyl ether,

Monomer (a2): t-butyl vinyl ether and carboxylic acid vinyl ester.

The proportion of the fluoroolefin units in the hydroxy group-containing fluoroolefin copolymer, is preferably from 30 to 70 mol %, particularly preferably from 40 to 60 mol %, in all the units (100 mol %) of the copolymer. When the proportion of the fluoroolefin units is at least the lower limit value, the laminate sheet is more excellent in flame proofing property and weather resistance. When the proportion of the fluoroolefin units is at most the upper limit value, the fluorinated resin layer is excellent in adhesion to the fiber-reinforced resin sheet layer.

The proportion of the monomer (a1)) units is preferably from 0.5 to 20 mol %, particularly preferably from 1 to 15 mol %, in all the units (100 mol %) of the copolymer. When the proportion of the monomer (a1) units is at least the lower limit value, the fluorinated resin layer is excellent in adhesion to the fiber-reinforced resin sheet. When the proportion of the monomer (a1) units is at most the upper limit value, the laminate sheet is excellent in flexibility.

The proportion of the monomer (a2) units is preferably from 20 to 60 mol %, particularly preferably from 30 to 50 mol %, in all the units (100 mol %) of the copolymer. When the proportion of the monomer (a2) units is at least the lower limit value, the laminate sheet is excellent in flexibility. When the proportion of the monomer (a2) units is at most the above upper limit value, the fluorinated resin layer is excellent in adhesion to the fiber-reinforced resin sheet layer. Monomer (a2) is particularly preferably a monomer having a linear or branched alkyl group with at least three carbon atoms.

The number average molecular weight of the hydroxy group-containing fluoroolefin copolymer is preferably from 3,000 to 50,000, particularly preferably from 5,000 to 30,000. When the number average molecular weight of the copolymer is at least the lower limit value, the heat resistance is excellent. When the number average molecular weight of the copolymer is at most the upper limit value, it is easily soluble in the solvent.

Commercial products of the hydroxy group-containing fluoroolefin copolymer may, for example, be LUMIFLON (registered trademark) series (such as LF200, LF100 or LF710) (manufactured by Asahi Glass Company, Limited), ZEFFLE (registered trademark) GK series (such as GK-500, GK-510, GK-550, GK-570 or GK-580) (manufactured by Daikin Industries, Ltd.), FLUONATE (registered trademark) series (such as K-700, K-702, K-703, K-704, K-705 or K-707) (manufactured by DIC Corporation), or ETERFLON series (such as 4101, 41011, 4102, 41021, 4261A, 4262A, 42631, 4102A, 41041, 41111 or 4261A) (manufactured by Eternal Chemical Co., Ltd.)

The fluoroolefin copolymer having reactive functional group is cured by a curing agent thereby to form a fluorinated resin in the fluorinated resin layer. The curing agent for the hydroxy group-containing fluoroolefin copolymer may be an isocyanate type curing agent or a melamine type curing agent such as methylol melamine.

As mentioned above, the fluorinated resin in the fluorinated resin layer is a cured product of a homopolymer or copolymer of a fluoroolefin having a thermal plasticity, a homopolymer or a copolymer of a fluoroolefin having a solvent solubility, or a fluoroolefin copolymer having a reactive functional group.

The proportion of the fluorinated resin in the fluorinated resin layer is preferably at least 50 mass %, more preferably at least 60 mass %, particularly preferably at least 75 mass %, in the fluorinated resin layer (100 mass %). When the proportion of the fluorinated resin is at least the above lower limit value, the laminate sheet is excellent in flame proofing property or weather resistance.

### <Ultraviolet Absorber>

The ultraviolet absorber contained in the fluorinated resin layer may, for example, be an organic type ultraviolet absorber or an inorganic type ultraviolet absorber.

The organic type ultraviolet absorber, which is a compound having a Tr-conjugate molecular structure, is an organic compound exhibiting an ultraviolet shielding capacity by absorbing ultraviolet light and emitting it as secondary energy deformed.

The organic type ultraviolet absorber may, for example, be a benzotriazole type ultraviolet absorber, a benzophenone type ultraviolet absorber, a salicylate type ultraviolet absorber, a cyano acrylate type ultraviolet absorber, a nickel type ultraviolet absorber or a triazine type ultraviolet absorber.

The inorganic type ultraviolet absorber is mainly one having two types of performance of ultraviolet absorbing performance inherent in an inorganic compound and scattering performance (called Mie scattering or Rayleigh scattering) in an ultraviolet-ray wavelength region obtained by controlling a particle size.

The inorganic type ultraviolet absorber may, for example, be titanium oxide, zinc oxide, cerium oxide or iron oxide.

The proportion of the ultraviolet absorber is preferably from 0.05 to 10 mass %, particularly preferably from 0.1 to 5 mass %, in the fluorinated resin layer (100 mass %). When the proportion of the ultraviolet absorber is at least the above lower limit value, the laminate sheet is excellent in flame proofing property. When the proportion of the ultraviolet absorber is at most the above upper limit value, the laminate sheet is excellent in the flame proofing property.

### <Other Resins>

The fluorinated resin layer may contain a resin other than the fluorinated resin, as the case requires.

Such other resins are preferably PMMA, polycarbonate, polyarylate, polycycloolefin, in view of compatibility with the fluorinated resin and solvent-solubility.

The combination of the fluorinated resin and such other resins is preferably a combination of PVDF and PMMA, from the viewpoint of flame proofing property, weather resistance and solvent-solubility.

The proportion of such other resins is preferably at most 60 mass %, particularly preferably at most 40 mass %, in the fluorinated resin layer (100 mass %), in view of flame proofing property and weather resistance. In the case of the combination of PVDF and PMMA, the proportion of PMMA is preferably at least 10 mass %, particularly preferably at least 20 mass %, in view of solvent-solubility.

### <Other Additive>

The fluorinated resin layer may contain other additives other than the ultraviolet absorber, as the case requires.

Such another additive may, for example, be a light stabilizer, an antioxidant, an infrared absorber, a flame retardant, a flame-retarding filler, an organic pigment, an inorganic pigment or a dye.

### (Laminate Sheet)

The thickness (at intersection points of glass fibers) of the laminate sheet is preferably at most 1,000 μm, particularly preferably at most 400 μm, in view of e.g. excellent transparency and processability. The thickness of the laminate sheet is preferably at least 24 μm, particularly preferably at least 50 μm, in view of e.g. excellent strength.

The total light transmittance of the laminate sheet is at least 85%, preferably at least 87%, particularly preferably at least 89%.

The total light transmittance of the laminate sheet is measured by illuminant D, in accordance with JIS K7361-1: 1997.

The total light transmittance of the laminate sheet can be increased by reducing air gaps in the laminate sheet. For example, according to the process for producing a laminate sheet of the present invention as mentioned below, it is possible to reduce the air gaps in the laminate sheet. Therefore, it is possible to suppress light scattering due to the difference in refractive indices between the glass fibers or the resin material and air in the air gaps, whereby the total light transmittance of the laminate sheet can be at least 85%.

The haze of the laminate sheet is at most 30%, preferably at most 20%, particularly preferably at most 10%.

The haze of the laminate sheet is measured by illuminant D, in accordance with JIS K7361-1: 1997.

The haze of the laminate sheet can be reduced by reducing air gaps in the laminate sheet, and further reducing the difference (absolute value) between the refractive index of the glass fibers and the refractive index of the resin material. For example, the haze of the laminate sheet can be at most 30% by reducing air gaps in the laminate sheet by the process for producing a laminate sheet of the present invention as mentioned below, and further adjusting the difference (absolute value) between the refractive index of the glass fibers and the refractive index of the resin material to be at most 0.20.

### Other Embodiments

The laminate sheet of the present invention is not limit to ones shown in drawings so long as it is one having a layer of a fiber-reinforced resin sheet made of a matrix containing a fluorine atom-free resin and a glass fiber cloth having an open area ratio of at most 20%, embedded in the matrix, and a fluorinated resin layer containing a fluorinated resin and an ultraviolet absorber, provided on at least one side of the layer of a fiber-reinforced resin sheet.

For example, as shown in FIG. 2, it may be laminate sheet 10 having a layer of a fiber-reinforced resin sheet made of matrix 12 and glass fiber cloth 14 embedded in matrix 12, and fluorinated resin layer 16 provided on one side of the layer of a fiber-reinforced resin sheet.

Further, other layers (such as a droplet flowing layer, a protective layer and an adhesive layer) may be provided on one side of the layer of a fiber-reinforced resin sheet, on the surface of the fluorinated resin layer, between the layer of a fiber-reinforced resin sheet and a fluorinated resin layer, and the like.

### (Operation and Effect)

The laminate sheet of the present invention as described above, which has a glass fiber cloth having an open area ratio of at most 20%, embedded in the matrix, has flame proofing property. Further, the resin material constituting the matrix is free from fluorine atoms, and therefore the absolute value of the difference between the refractive index of the glass material and the refractive index of the glass fiber constituting the glass fiber cloth is relatively small as compared with a case where a fluorinated resin is used as the matrix, whereby a transparency is imparted. Further, a fluorinated resin layer containing a fluorinated resin and an ultraviolet absorber is provided on at least one side of the fiber-reinforced resin sheet layer, whereby weather resistance is excellent.

### [Process for Producing Laminate Sheet]

The laminate sheet of the present invention is preferably produced by the following process (A) and (B). The process (A) is a process for forming a fluorinated resin of the fluorinated resin layer by curing a fluoroolefin copolymer having a reactive functional group, and the process (B) is a process for forming the fluorinated resin layer from a film or sheet of a fluorinated resin.

(A): A process for producing a laminate sheet, which comprises: producing the fiber-reinforced resin sheet, coating one side or both sides of the fiber-reinforced resin sheet with a solution of a curable resin material containing a fluoroolefin copolymer having reactive functional groups and an ultraviolet absorber, removing a solvent to form a layer of the curable resin material, and then curing the curable resin material to form a fluorinated resin layer containing the ultraviolet absorber.

(B): A process for producing a laminate sheet, which comprises: producing the fiber-reinforced resin sheet, and then laminating a film or sheet of a fluorinated resin containing an ultraviolet absorber, on one side or both sides of the fiber-reinforced resin sheet, or a process for producing a laminate, which comprises: producing the fiber-reinforced resin sheet on a film or sheet of a fluorinated resin containing an ultraviolet absorber to integrate both of them.

In the process (A), the solution of a curable resin material contains a fluoroolefin copolymer having a reactive functional group, an ultraviolet absorber and a solvent, and as the case requires, it may contain e.g. an additive.

In the case of curing the fluoroolefin copolymer having a reactive functional group, such as a hydroxy group-containing fluoroolefin copolymer, a curing agent reactive with a hydroxy group, such as an isocyanate type curing agent or a melamine type curing agent is used.

The solvent may, for example, be toluene, xylene, butyl acetate, methyl ethyl ketone or methylene chloride. The proportion of the fluoroolefin copolymer in the solution of a curable resin material is preferably from 30 to 85 mass %, particularly preferably from 40 to 75 mass %, in the solution (100 mass %).

The solution may contain the following additives for adjusting the properties of the solution, other than the above-mentioned additives.

A surface adjustor, an emulsifier, a film-forming assistant (high boiling point organic solvent), a thickener, a preservative, a silane coupling agent, an anti-foaming agent and the like.

The removal of the solvent after the solution of a curable resin material is applied, is usually carried out by heating.

The heating temperature may be at least a temperature at which the solvent evaporates, and lower than a temperature at which a fluoroolefin copolymer, an ultraviolet absorber and additives are decomposed.

The heating time may be a time at which a solvent is completely evaporated and removed.

The curing of the fluoroolefin copolymer having reactive functional groups is usually carried out by heating.

The heating temperature may, for example, be at least a temperature at which the curing agent is reacted with hydroxy groups in the hydroxy group-containing fluoroolefin copolymer, and lower than a temperature at which a fluorinated resin, an ultraviolet absorber and additives are decomposed.

The heating time may properly be set depending on the extent of curing of the fluoroolefin copolymer.

The process (B) is preferably the former process of producing a fiber-reinforced resin sheet and then laminating a film or sheet of the fluorinated resin. In the case of latter process, the fiber-reinforced resin sheet is produced on one sheet of the film or sheet of the fluorinated resin, whereby it is possible to obtain a laminate having the fluorinated resin layer on one side of the layer of the fiber-reinforced resin sheet, or the fiber-reinforced resin sheet is produced between two sheets of the films or sheets of the fluorinated resin, whereby it is possible to obtain a laminate having the fluorinated resin layer on both sides of the layers of the fiber-reinforced resin sheets.

In the process (B), the film or sheet of the fluorinated resin contains an ultraviolet absorber, and it may contain e.g. an additive as the case requires.

The film or sheet of the fluorinated resin may be produced by a known molding method.

The film or sheet of the fluorinated resin and the fiber-reinforced resin sheet may, for example, be bonded by heat fusion bonding by means of heat pressing or by adhesion by means of an adhesive.

The fiber-reinforced resin sheet is preferably produced by any one of the following methods, depending on whether the fluorine atom-free resin in the matrix is a cured product of a curable resin or a thermoplastic resin. In order to impregnate the glass fiber cloth, a material having a low viscosity is needed, and therefore in order to impregnate it with a solid or a material having a high viscosity, a solvent is used.

In a case where the resin material forming the matrix is a curable resin, and further in a case where it is possible to impregnate the glass fiber cloth with a curable resin material containing the curable resin, the glass fiber cloth is impregnated with the curable resin material to carry out curing, whereby it is possible to produce a fiber-reinforced resin sheet. In such a case, it is necessary that the curable resin in the curable resin material is a liquid resin having a low viscosity.

In the case of a solid or high-viscous liquid curable resin, it is difficult to impregnate the glass fiber cloth with a curable resin material containing the curable resin. In such a case, a solvent is blended with the curable resin material to be a liquid material capable of impregnating the glass fiber cloth, the glass fiber cloth is impregnated with the liquid material, and then the solvent is removed to form a curable resin material having the glass fiber cloth embedded therein. Thereafter, the curable resin is cured, whereby it is possible to produce a fiber-reinforced resin sheet. Further, in e.g. the case of forming a fiber-reinforced resin sheet having a relatively large amount of a matrix, a glass fiber cloth is impregnated with a solution of a curable resin material, followed by removing a solvent, then the liquid curable resin material containing no solvent is applied thereon, and then the curable resin material is cured, whereby it is possible to produce a fiber-reinforced resin sheet.

In a case where the resin material forming a matrix is a thermoplastic resin, the thermoplastic resin which is a solid, is dissolved in a solvent so that a glass fiber cloth is impregnated therewith, and then the solvent is removed, whereby it is possible to produce a fiber-reinforced resin sheet. The thermoplastic resin is preferably a thermoplastic resin soluble in a general-purpose solvent.

In a case where the resin material for forming a matrix is used as blended with a solvent, the solvent may, for example, be ethyl acrylate, butyl acrylate, acetone, ethyl benzene, ethylene oxide, methyl chloride, xylene, chloroacetone, chlorosulfonic acid, chlorotoluene, chloroform, ethyl acetate, methyl acetate, cyclohexanone, cyclohexane, dipentene, tetrachloroethane, tetrachlorobenzene, toluene, nitrobenzene, nitromethane, carbon disulfide, perchloroethylene, hexaaldehyde, hexane, hexyl alcohol, mercaptan, monochloroacetic acid, monochloribenzene, carbon tetrachloride or a mixture thereof. The proportion of the resin material to the total (100 mass %) of the solvent and the resin material is preferably from 20 to 95 mass %, particularly preferably from 40 to 85 mass %.

The resin material may contain a silane coupling agent for increasing adhesion of a matrix and a glass fiber cloth, in addition to the above-mentioned additive. The silane coupling agent may, for example, be epoxysilane or aminosilane.

The method for impregnating a glass fiber cloth with a resin material may, for example, be a method having the following operations 1 to 5. Here, the material for forming a matrix means a curable resin material (a liquid capable of impregnation) containing no solvent, a mixture of a solvent and a curable resin material, or a mixture of a solvent with a thermoplastic resin (which may contain e.g. an additive).

Operation 1: A glass fiber cloth is provided on an underlying film.

Operation 2: A prescribed amount of a material for forming a matrix is supplied to the glass fiber cloth.

Operation 3: A covering film is placed on the glass fiber cloth impregnated with the material for forming a matrix.

Operation 4: A hand roller is reciprocated on the covering film to remove bubbles from the glass fiber cloth impregnated with the material for forming a matrix.

Operation 5: The covering film is peeled, and a solvent is removed in a case where the material for forming a matrix contains the solvent. In a case where the resin material is a curable resin material, the curable resin material is cured after the solvent is removed.

The curing of the curable resin material is carried out by heating or light irradiation.

The heating temperature may, for example, be at least a temperature at which a curable resin and a curing agent are reacted, and lower than a temperature at which e.g. a curable resin material and additives are decomposed, or lower than a temperature at which an underlying film is deformed.

The heating time may properly be set depending on the extent of curing of the curable resin material.

Light is preferably ultraviolet light. Accumulative light amount or the like may properly be set depending on the extent of curing of the curable resin material.

### (Operation and Effect)

According to the process for producing a laminate sheet of the present invention as mentioned above, the resin material can easily infiltrate into air gaps between the glass fibers since the glass fiber cloth is impregnated with the resin material for forming a matrix. As a result, it is possible to reduce air gaps in the matrix obtainable. Therefore it is possible to suppress light scattering due to the difference of indices between the glass fibers or the matrix resin and air in the air gaps, whereby the total light transmittance of the laminate sheet can be at least 85%.

### Examples

Now, the present invention will be described in further detail with reference to Examples, but it should be understood that the present invention is by no means restricted thereto.

Ex. 1 to 4, 6, 8 to 10 are Examples of the present invention, and Ex. 5 and 7 are Comparative Examples.

### [Evaluation Method]

### (Total Light Transmittance and Haze)

Using a haze meter (NDH50000, manufactured by Nippon Denshoku Industries Co., Ltd.), the total light transmittance and the haze of a fiber-reinforced resin sheet were measured by a D light source, in accordance with JIS K7361-1: 1997.

### (Accelerated Weather Resistance Test)

Using an accelerated weather resistance tester (Eye Super UV Tester, manufactured by Suga Test Instruments Co., Ltd.), an accelerated weather resistance test was carried out. The total light transmittance and the haze of a fiber-reinforced resin sheet after exposure for 225 hours were measured.

### (Flame Proofing Property Evaluation 1)

A test specimen (30 cm×30 cm) of a laminate sheet was fixed so that the surface of the test specimen would be inclined at 45° to a horizontal direction. The test specimen was exposed to flame (length: 2.5 cm) of a spirit lamp from the bottom of the test specimen, and the time until the test specimen ignited was measured to carry out evaluation based on the following standards.

◯ (Good): Time until ignition was at least 30 seconds.

Δ (Permissible): Time until ignition was at least 10 seconds and less than 30 seconds.

X (Bad): Time until ignition was less than 10 seconds.

### (Flame Proofing Property Evaluation 2)

A test specimen (30 cm×30 cm) of a laminate sheet was fixed so that the surface of the test specimen would be horizontal. A cotton was disposed below the test specimen. After igniting a timber (2 cm×2 cm×2 cm), the timber was placed on the test specimen, and the time until the cotton ignited was measured to carry out evaluation based on the following standards.

◯ (Good): Time until ignition was at least 5 minutes.

Δ (Permissible): Time until ignition was at least 1 minute and less than 5 minutes.

X (Bad): Time until ignition was less than 1 minute.

### Ex. 1

A glass fiber woven fabric (using a glass fiber made of E glass, refractive index of glass: 1.55, thickness of glass single fiber: 0.162 Tex, number of glass single fibers constituting yarn: 130, weaving density (lengthwise direction and lateral direction): 60 mesh, basis weight of woven fabric: 100 g/m², thickness of woven fabric at an intersection point of yarn: 97 μm, open area ratio of cloth: 3%, total light transmittance of woven fabric: 50%) obtained by plain-weaving glass fiber yarn, was prepared.

To a xylene solution (solid content: 80 mass %) of an epoxy acrylate resin (epoxy acrylate oligomer, tradename: AG-1, manufactured by KSM K.K., refractive index after curing: 1.55, intrinsic viscosity: 800 mPas) of which refractive index was adjusted, 1 part by mass of 1-hydroxycyclohexyl phenyl ketone (tradename: Irgacure (registered trademark) 184, manufactured by Ciba Geigy Company) based on 100 parts by mass of the epoxy acrylate resin, was added to prepare a solution of a material for forming a matrix (1).

Further, to the above epoxy acrylate resin which was not diluted with xylene, 1 part by mass of 1-hydroxycyclohexyl phenyl ketone based on 100 parts by mass of the epoxy acrylate resin was added to prepare a material (2) for forming a matrix.

To a xylene solution (solid content: 60 mass %) of a fluoroolefin/vinyl ether copolymer (tradename: LUMIFLON (registered trademark) LF200, manufactured by Asahi Glass Company, Limited, this hydroxy group-containing copolymer will be hereinafter referred to as “LF200”), 18.3 parts by mass of polyisocyanate for coating (tradename: Coronate HX, manufactured by Nippon Polyurethane Industry Co., Ltd.) and 10 parts by mass a benzophenone type ultraviolet absorber (tradename: CYASORBUV531, manufactured by CYTEC Industries Inc.), per 100 parts by mass of LF200, were added to prepare a solution (1) for forming a fluorinated resin layer.

The above glass fiber woven fabric was spread on a polyethylene terephthalate (hereinafter, referred to as “PET”) film with a thickness of 50 μm. The solution of material (1) for forming a matrix was supplied to the center of the glass fiber woven fabric, and the PET film with a thickness of 50 μm was placed on the glass fiber woven fabric. A hand roller was reciprocated on the PET film to remove bubbles from the glass fiber woven fabric impregnated with the solution of material (1) for forming a matrix.

The PET film placed on the glass fiber woven fabric was peeled off, and the glass fiber cloth impregnated with the solution of material (1) for forming a matrix, was put in a hot air constant temperature oven. The hot air constant temperature oven was heated at 80° C. for one hour to remove a solvent.

The material (2) for forming a matrix was applied on the surface of the glass fiber woven fabric having material (1) for forming a matrix impregnated, and then the PET film with a thickness of 50 μm was placed on the material (2) for forming a matrix layer. A hand roller was reciprocated on the PET film to remove bubbles from material (2) for forming a matrix.

In a state where the PET films were laminated on both sides, the laminate was irradiated with an ultraviolet ray for four minutes with a lamp at an outpour power of 2 kw, using a conveyer-type UV irradiation apparatus (ECS-301 G, manufactured by Eye Graphics Co., Ltd.) to cure the epoxy acrylate resin, whereby a fiber-reinforced resin sheet was formed. The thickness (at an intersection point of glass fibers) of the fiber-reinforced resin sheet was about 117 μm.

After one of the PET films was peeled off, solution (1) for forming a fluorinated resin layer was applied on the surface of the fiber-reinforced resin sheet, by using a #14 bar coater as defined in JIS K5400. The fiber-reinforced resin sheet coated with solution (1) for forming a fluorinated resin layer was put in a hot air constant temperature oven. The hot air constant temperature oven was heated at 80° C. for one hour to remove a solvent, and at the same time, LF200 was cured to form a fluorinated resin layer having a thickness of about 30 μm. The other PET film was peeled off, and then a fluorinated resin layer having a thickness of about 30 μm was formed on the surface of the fiber-reinforced resin sheet in the same manner to produce a laminate sheet. The thickness (at an intersection point of glass fibers) of the laminate sheet was 175 μm. The evaluation result of the laminate sheet is shown in Table 1.

### Ex. 2

A laminate sheet was produced in the same manner as in Ex. 1 except that the epoxy acrylate resin in Ex. 1 was changed to the epoxy acrylate resin (epoxy acrylate oligomer, tradename: AG-2, manufactured by KSM K.K., refractive index after curing: 1.53, intrinsic viscosity: 630 mPas,) having a refractive index adjusted. The thickness (at an intersection point of glass fibers) of the fiber-reinforced resin sheet was 125 μm, the thickness of the fluorinated resin layer was 30 μm, and the thickness (at an intersection point of glass fibers) of the laminate sheet was 186 μm. The evaluation result of the laminate sheet is shown in Table 1.

### Ex. 3

A laminate sheet was produced in the same manner as in Ex. 1 except that the epoxy acrylate resin in Ex. 1 was changed to the epoxy acrylate resin (epoxy acrylate oligomer, tradename: AG-3, manufactured by KSM K.K., refractive index after curing: 1.51, intrinsic viscosity: 690 mPas) having a refractive index adjusted. The thickness (at an intersection point of glass fibers) of the fiber-reinforced resin sheet was 118 μm, the thickness of the fluorinated resin layer was 30 μm, and the thickness (at an intersection point of glass fibers) of the laminate sheet was 178 μm. The evaluation result of the laminate sheet is shown in Table 1.

### Ex. 4

A laminate sheet was produced in the same manner as in Ex. 1 except that the glass fiber cloth in Ex. 1 was changed to a glass fiber woven fabric (using a glass fiber made of borosilicate crown glass, refractive index of glass: 1.51, thickness of glass single fiber: 0.162 Tex, number of glass single fibers constituting yarn: 130, weaving density (lengthwise direction and lateral direction): 60 mesh, basis weight of woven fabric: 102 g/m², thickness of woven fabric at an intersection point of yarns: 99 μm, open area ratio of woven fabric: 3%, total light transmittance of woven fabric: 47%) obtained by plain-weaving glass fiber yarn. The thickness (at an intersection point of glass fibers) of the fiber-reinforced resin sheet was 123 μm, the thickness of the fluorinated resin layer was 30 μm, and the thickness (at an intersection point of glass fibers) of the laminate sheet was 181 μm. The evaluation result of the laminate sheet is shown in Table 1.

### Ex. 5

A laminate sheet was produced in the same manner as in Ex. 1 except that the glass fiber woven fabric in Ex. 1 was changed to the glass fiber woven fabric (using a glass fiber made of E glass, refractive index of glass: 1.55, thickness of glass single fiber: 0.162 Tex, number of glass single fibers constituting yarn: 130, weaving density (lengthwise direction and lateral direction): 40 mesh, basis weight of woven fabric: 67 g/m², thickness of woven fabric at an intersection point of yarns: 95 μm, open area ratio of woven fabric: 21%, total light transmittance of woven fabric: 61.7%) obtained by plain-weaving glass fiber yarn. The thickness (at an intersection point of glass fibers) of the fiber-reinforced resin sheet was 115 μm, the thickness of the fluorinated resin layer was 30 μm, and the thickness (at an intersection point of glass fibers) of the laminate sheet was 173 μm. The evaluation result of the laminate sheet is shown in Table 2.

### Ex. 6

A fiber-reinforced resin sheet was formed in the same manner as in Ex. 1.

After the PET films on both sides were peeled off, ETFE films (tradename: Fluon Aflex film 25RAS, manufactured by Asahi Glass Company, Limited, containing 0.20 mass % of cerium oxide fine particles (ultraviolet absorber)) having a thickness of 25 μm, one side of which was subjected to corona discharge treatment, were laminated on both sides of the fiber-reinforced resin sheet, followed by heat pressing at 230° C. at 8 MPa for 2 minutes to produce a laminate sheet. The thickness (at an intersection point of glass fibers) of the laminate sheet was 169 μm. The evaluation result of the laminate sheet is shown in Table 2.

### Ex. 7

A fiber-reinforced resin sheet was formed in the same manner as in Ex. 1. The fiber-reinforced resin sheet was subjected to an accelerated weather resistance test in the same manner as in the laminate sheet. The results are shown in Table 2.

### Ex. 8

A glass fiber woven fabric (using a glass fiber made of silica glass containing at least 96 mass % of SiO₂, refractive index of glass: 1.45, thickness of glass single fiber: 0.225 Tex, number of glass single fibers constituting yarn: 130, weaving density (lengthwise direction and lateral direction): 60 mesh, basis weight of woven fabric: 140 g/m², thickness of woven fabric at an intersection point of yarns: 135 μm, open area ratio of woven fabric: 5%, total light transmittance of woven fabric: 43%) obtained by plain-weaving glass fiber yarn, was prepared.

A solution of material (3) for forming a matrix obtained by dissolving polyvinyl chloride having a polymerization degree of 1,500 in methanol at a solid content concentration of 50 mass %, was prepared.

The glass fiber woven fabric was spread on a PET film having a thickness of 50 μm. The solution of material (3) for forming a matrix layer was supplied to the center of the glass fiber woven fabric, for forming a matrix, and then the PET film with a thickness of 50 μm was placed on the glass fiber woven fabric. A hand roller was reciprocated on the PET film to remove bubbles from the glass fiber woven fabric impregnated with the solution of material (3) for forming a matrix.

The PET film placed on the glass fiber woven fabric was peeled off, and the glass fiber woven fabric impregnated with the solution of material (3) for forming a matrix was put in a hot air constant temperature oven. The hot air constant temperature oven was heated at 50° C. for one hour to remove a solvent.

After the PET films on both sides were peeled, ETFE films (tradename: Fluon Aflex film 25RAS, manufactured by Asahi Glass Company, Limited, containing 0.20 mass % of cerium oxide fine particles (ultraviolet absorber)) having a thickness of 25 μm, of which one side was subjected to corona discharge treatment, were laminated on both sides of the matrix layer, followed by heat pressing at 210° C. at 8 MPa for 2 minutes to produce a laminate sheet. The thickness (at an intersection point of glass fibers) of the laminate sheet was 181 μm. The evaluation result of the laminate sheet is shown in Table 3.

### Ex. 9

A laminate sheet was produced in the same manner as in Ex. 8 except that, a two-liquid heat curable product (grade: KER-6150, manufactured by Shin-Etsu Chemical Co., Ltd. hereinafter this curable product including its cured product will be referred to as a silicone resin) of methyl phenyl silicone was used instead of the solution of material (3) for forming a matrix, PET films on both sides were peeled after operation of impregnation, then the ETFE films were subjected to heat pressing without drying, and that the conditions of the heat pressing was changed to 140° C., 8 MPa and 15 minutes. The thickness (at an intersection point of glass fibers) of the laminate sheet was 185 μm. The evaluation result of the laminate sheet is shown in Table 3.

### Ex. 10

A laminate sheet was produced in the same manner as in Ex. 8 except that a solution of material (4) for forming a matrix obtained by dissolving polyvinyl acetate having a polymerization degree of 1,500 in a thinner for a coating material at a solid content concentration of 40 mass %, was used instead of the solution of material (3) for forming a matrix, and that the drying conditions after the operation of impregnation was changed to 60° C. and one hour. The thickness (at an intersection point of glass fibers) of a laminate sheet was 177 μm. The evaluation result of the laminate sheet is shown in Table 3.

TABLE 1

| | | Ex. | | | |
|---|---|---|---|---|---|
| | | 1 | 2 | 3 | 4 |
| Resin material | | Epoxy | Epoxy | Epoxy | Epoxy |
| | | acrylate | acrylate | acrylate | acrylate |
| | | resin | resin | resin | resin |
| refractive index of resin | | 1.55 | 1.53 | 1.51 | 1.55 |
| cured product | | | | | |
| Refractive index of glass | | 1.55 | 1.55 | 1.55 | 1.51 |
| fiber | | | | | |
| Difference (absolute value) | | 0 | 0.02 | 0.04 | 0.04 |
| of refractive index | | | | | |
| Open area ratio of glass | | 3 | 3 | 3 | 3 |
| fiber cloth (%) | | | | | |
| Fluorinated resin | | LF200 cured | LF200 cured | LF200 cured | LF200 cured |
| | | product | product | product | product |
| Before | Total light | 91.9 | 90.8 | 88.6 | 89.5 |
| accelerated | transmittance | | | | |
| weather | (%) | | | | |
| resistance | Haze (%) | 4.6 | 26.3 | 38.8 | 35.1 |
| test | | | | | |
| After | Total light | 89.2 | 87.9 | 87.0 | 86.3 |
| accelerated | transmittance | | | | |
| weather | (%) | | | | |
| resistance test | Haze (%) | 4.3 | 24.8 | 35.4 | 32.9 |

| | | | | |
|---|---|---|---|---|
| Flame proofing property | ◯ | ◯ | ◯ | ◯ |
| evaluation 1 | | | | |
| Flame proofing property | ◯ | ◯ | ◯ | ◯ |
| evaluation 2 | | | | |

TABLE 2

| | | Ex. | | |
|---|---|---|---|---|
| | | 5 | 6 | 7 |
| Resin material | | Epoxy | Epoxy | Epoxy |
| | | acrylate resin | acrylate | acrylate resin |
| | | | resin | |
| refractive index of resin cured | | 1.55 | 1.55 | 1.55 |
| product | | | | |
| Refractive index of glass fiber | | 1.55 | 1.55 | 1.55 |
| Difference (absolute value) of | | 0 | 0 | 0 |
| refractive index | | | | |
| Open area ratio of glass fiber cloth | | 21 | 3 | 3 |
| (%) | | | | |
| Fluorinated resin | | LF200 cured | ETFE | — |
| | | product | | |
| Before | Total light | 95.1 | 94.5 | 90.0 |
| accelerated | transmittance (%) | | | |
| weather | Haze (%) | 3.2 | 5.0 | 8.4 |
| resistance test | | | | |
| After | Total light | 93.2 | 93.5 | 84.2 |
| accelerated | transmittance (%) | | | |
| weather | Haze (%) | 3.5 | 5.7 | 8.4 |
| resistance test | | | | |

| | | | |
|---|---|---|---|
| Flame proofing property | ◯ | ◯ | — |
| evaluation 1 | | | |
| Flame proofing property | X | ◯ | — |
| evaluation 2 | | | |

TABLE 3

| | | Ex. | | |
|---|---|---|---|---|
| | | 8 | 9 | 10 |
| Resin material | | Polyvinyl | Silicone | polyvinyl |
| | | chloride | resin | acetate |
| refractive index of resin | | 1.55 | 1.44 | 1.46 |
| Refractive index of glass fiber | | 1.45 | 1.45 | 1.45 |
| Difference (absolute value) of | | 0.10 | 0.01 | 0.01 |
| refractive index | | | | |
| Open area ratio of glass fiber cloth | | 5 | 5 | 5 |
| (%) | | | | |
| Fluorinated resin | | ETFE | ETFE | ETFE |
| Before | Total light | 92.3 | 91.1 | 90.8 |
| accelerated | transmittance (%) | | | |
| weather | Haze (%) | 5.5 | 12.8 | 14.7 |
| resistance test | | | | |
| After | Total light | 91.3 | 90.2 | 89.9 |
| accelerated | transmittance (%) | | | |
| weather | Haze (%) | 6.9 | 13.5 | 17.1 |
| resistance test | | | | |

| | | | |
|---|---|---|---|
| Flame proofing property evaluation 1 | ◯ | ◯ | ◯ |
| Flame proofing property evaluation 2 | ◯ | ◯ | ◯ |

The laminate sheet in each of Ex. 1 to 4, 6 and 8 to 10 were excellent in transparency, weather resistance and flame proofing property.

The laminate sheet in each of Ex. 1, 2 and 6 was more excellent in transparency than Ex. 3 and 4. The reason is considered to be that, in the laminate sheet in each of Ex. 3 and 4, the difference (absolute value) of the refractive index of the glass fiber and the refractive index of the cured product of the curable resin was more than 0.20.

The laminate sheet in Ex. 5, of which glass fiber woven fabric at a high open area ratio, was insufficient in flame proofing property.

The laminate sheet in Ex. 7, which has no fluorinated resin layer, was insufficient in weather resistance.

### INDUSTRIAL APPLICABILITY

The laminate sheet of the present invention, which has flame proofing property and excellent weather resistance and transparency, are suitable as a membrane material (such as a roof material, a ceiling material, an exterior wall material or an interior wall material) for membrane structure buildings (such as sports facilities, large-scale green houses and atria) or a covering material for agricultural green houses.

The laminate sheet of the present invention may be used for various applications not only for membrane materials for membrane structure buildings or covering materials for agricultural green houses, but also for a fiber-reinforced resin material. As other applications, the laminate sheet is useful for e.g. an outdoor use plate material (such as a sound-proof wall, a wind break fence, a wave barrier fence, a canopy for garages, a shopping mall, a wall for walking passage or a ceiling material), an anti-shattering film for glass, a heat resistance/water resistance sheet, a building material (such as a tent material for tent warehouses, a membrane material for sunshades, a partial roof material for skylight, an window material alternative to glass, a partition membrane material for flame proofing property, a curtain, an exterior wall reinforcing material, an water proof membrane, a smoke proof membrane, a non-combustible transparent partition, a road reinforcing material, an interior (such as lighting, an wall surface, a blind) or an exterior (such as a tent or a sign board)), life leisure goods (such as a fishing rod, a racket, a golf club and a screen), a material for automobiles (such as a hood, a dumping material or a body), a material for airplanes, a material for ships, an exterior material for home electric appliances, a tank, a container interior wall, a filter, a membrane material for construction work, an electronic material (such as a printed board material, a wiring board material, an insulation film or a release film), a surface material for a solar cell module, a mirror protection material for solar thermal power generation or a solar water heater.

This application is a continuation of PCT Application No. PCT/JP2014/069247, filed on Jul. 18, 2014, which is based upon and claims the benefit of priority from Japanese Patent Application No. 2013-155802 filed on Jul. 26, 2013 and Japanese Patent Application No. 2013-267915 filed on Dec. 25, 2013. The contents of those applications are incorporated herein by reference in their entireties.

### REFERENCE SYMBOLS

10: Laminate sheet
12: Matrix
14: Glass fiber cloth
16: Fluorinated resin layer

What is claimed is:

1. A laminate sheet, comprising:
a layer of a fiber-reinforced resin sheet, which comprises a matrix containing a fluorine atom-free resin, and a glass fiber cloth having an open area ratio of at most 20%, embedded in the matrix, and
a fluorinated resin layer containing an ultraviolet absorber, provided on at least one side of the layer of a fiber-reinforced resin sheet.

2. The laminate sheet according to claim 1, wherein the absolute value of the difference between the refractive index of the matrix and the refractive index of a glass fiber constituting the glass fiber cloth is at most 0.02.

3. The laminate sheet according to claim 1, wherein the total light transmittance of the laminate sheet is at least 85%.

4. The laminate sheet according to claim 1, wherein the haze of the laminate sheet is at most 30%.

5. The laminate sheet according to claim 1, wherein the fluorine atom-free resin is a cured product of a curable resin material.

6. The laminate sheet according to claim 1, wherein the fluorine atom-free resin is a thermoplastic resin.

7. The laminate sheet according to claim 1, wherein the fluorinated resin is a cured product of a fluoroolefin copolymer having reactive functional groups.

8. The laminate sheet according to claim 7, wherein the fluoroolefin copolymer having reactive functional groups is a copolymer having units derived from a fluoroolefin and units derived from a monomer having a reactive functional group, said monomer being copolymerizable with the fluoroolefin.

9. The laminate sheet according to claim 7, wherein the fluoroolefin copolymer having reactive functional groups is a fluoroolefin copolymer having hydroxy groups.

10. The laminate sheet according to claim 1, wherein the fluorinated resin is a homopolymer or copolymer having units derived from a fluoroolefin.

11. The laminate sheet according to claim 10, wherein the fluorinated resin is an ethylene/tetrafluoroethylene copolymer.

12. The laminate sheet according to claim 1, which is a membrane material for membrane structure buildings.

13. A process for producing the laminate sheet as defined in claim 7, which comprises:
producing the fiber-reinforced resin sheet,
coating one side or both sides of the fiber-reinforced resin sheet with a solution of a curable resin material containing a fluoroolefin copolymer having reactive functional groups and an ultraviolet absorber,
removing a solvent to form a layer of the curable resin material, and then
curing the curable resin material to form a fluorinated resin layer containing the ultraviolet absorber.

14. A process for producing the laminate sheet as defined in claim 10, which comprises:
producing the fiber-reinforced resin sheet, and then
laminating a film or sheet of the fluorinated resin on one side or both sides of the fiber-reinforced resin sheet.
